(19) United States
(12) Patent Application Publication
(10) Pub. No.: US 2008/0130085 A1
(43) Pub. Date: Jun. 5, 2008

(54) Permission device for electric safety lock

(75) Inventor: Roland Alfred Di Centa, London (GB)

Correspondence Address: MODIANO & ASSOCIATI, Via Meravigli, 16, Milan, 20123, omitted

(73) Assignee: CTO SOLUTIONS INC.

(21) Appl. No.: 11/584,660

(22) Filed: Oct. 23, 2006

(51) Int. Cl. G02F 1/03

(52) U.S. Cl. 359/245

(57) ABSTRACT

A permission device for an electric safety lock, particularly for inhibiting access to high-voltage areas, comprising high-voltage resistive elements, which receive in input the voltage of the area and are adapted to produce a voltage drop, a capacitive element being connected in series to the resistive element and being adapted to be charged by the resistive element, at least one control diode of an optical fiber being arranged so as to receive the discharge of the capacitive element, an oscillator being adapted to drive at least one indicator LED, the optical fiber sending a signal giving or denying permission to release the lock.

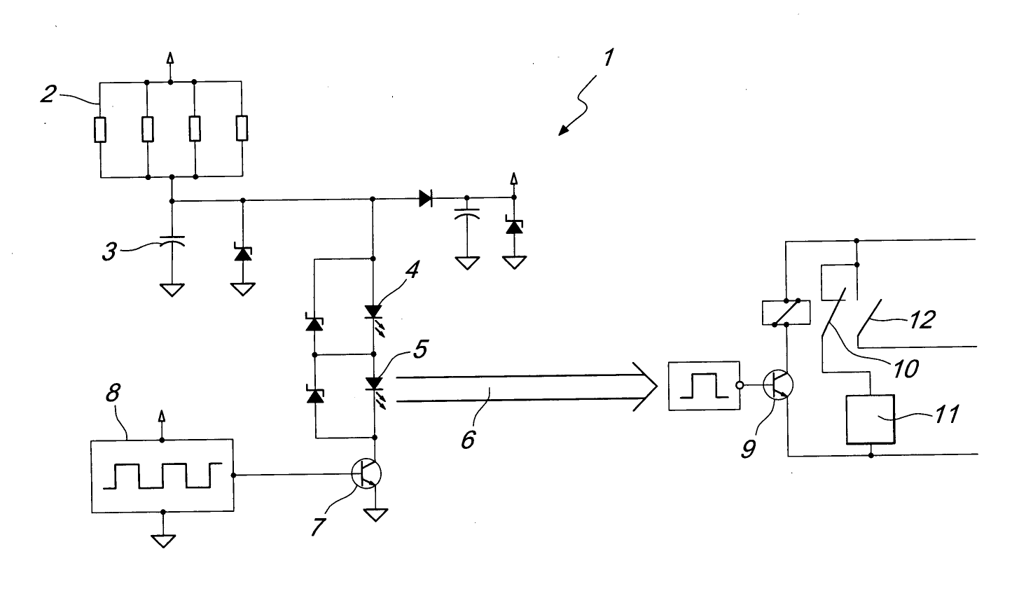

The present invention relates to a permission device for an electric safety lock, particularly for preventing access to high-voltage areas.

### BACKGROUND OF THE INVENTION

As is known, high-voltage areas are extremely hazardous for specialized and nonspecialized personnel. For this purpose, usually it is necessary to provide electric and/or mechanical locks which isolate these areas in order to prevent an operator from coming into contact with them accidentally.

However, access to these areas must of course be ensured in order to perform maintenance, part replacement and the like.

When an operator accesses the high-voltage area, he might not be aware of the fact that the area is live or not, and therefore there can be extremely severe problems if the operator accesses a high-voltage area assuming that power has been disconnected.

Therefore, it is not sufficient to have available a lock or in any case a lockout device which allows to access the high-voltage area by acting on an appropriate lockout device, which can also be a key, but the operator must be always aware, at all times, whether power is present or not.

Currently, there are no devices capable of giving the operator an indication of the presence of high voltage and of therefore acting consequently on the lockout or release mechanism in order to be able to access the area that is normally at high voltage.

### SUMMARY OF THE INVENTION

The aim of the present invention is to provide a permission device for an electric safety lock, particularly to allow or disallow access to high-voltage areas, which allows to detect automatically the presence or absence of voltage and consequently prevent or allow the release of the safety lock in order to allow access to the area that is normally at high voltage.

Within this aim, an object of the present invention is to provide a permission device for an electric safety lock which allows to indicate the presence of high voltage.

Another object of the present invention is to provide a permission device for an electric safety lock in which the electric lock is provided with a manual release in order to access the protected area even in case of potential malfunctions.

Still another object of the present invention is to provide a permission device for an electric safety lock which is highly reliable, relatively simple to provide and at competitive costs.

This aim and these and other objects, which will become better apparent hereinafter, are achieved by a permission device for an electric safety lock, particularly for inhibiting access to high-voltage areas, comprising high-voltage resistive means, which receive in input the voltage of said area and are adapted to produce a voltage drop, capacitive means being connected in series to said resistive means and being adapted to be charged by said resistive means, at least one control diode of an optical fiber being arranged so as to receive the discharge of said capacitive means, oscillator means being adapted to drive at least one indicator LED, said optical fiber sending a signal giving or denying permission to release said lock.

### BRIEF DESCRIPTION OF THE DRAWING

Further characteristics and advantages of the invention will become better apparent from the description of a preferred but not exclusive embodiment of the device according to the present invention, illustrated by way of non-limiting example in the accompanying drawing, wherein the only figure is a block diagram of the device according to the present invention.

### DESCRIPTION OF THE PREFERRED EMBODIMENTS

With reference to the FIGURE, the device according to the invention, generally designated by the reference numeral 1, comprises at least one, and preferably a plurality of high-voltage resistors 2, which are adapted to receive in input a high voltage signal HV, at the area where high voltage is present.

Capacitive means 3 are connected in series to the set of resistors 2, so as to be charged by such set of resistors 2. The set of resistors 2 provides a voltage drop and charges the capacitive means 3.

The capacitive means 3 discharge onto a series arrangement of a first LED diode 4 and a second diode 5 of a transmitter of an optical fiber 6. Discharge occurs across a MOSFET transistor 7 driven by an oscillator circuit 8.

Conveniently, the MOSFET transistor is interposed between the series arrangement of the LED diode 4 and the diode 5 of the optical fiber transmitter and the ground.

In turn, the optical fiber drives an additional MOS transistor 9, which transduces the intermittent optical signal that it receives into a control to energize a coil of a relay. The relay is provided with two normally-open contacts: a first contact 10 controls the coil of an electric lock 11, while a second contact 12 sends a voltage presence signal for any other indications or interlocks.

Substantially, therefore, the optical fiber carries an intermittent optical signal to the MOS transistor 9, which transduces a control signal for energizing a coil of the relay, the two contacts 10 and 12 of which are normally open.

The presence of the voltage signal therefore leads to a control signal emitted by the MOS transistor 9, which thus closes the first contact 10, activating the electric lock, i.e., locking out the high-voltage area, and to an additional voltage presence signal, produced by the closure of the second contact 12.

Therefore, if high voltage is present in the area of interest, the device according to the invention automatically operates the electric lock 11, thus preventing access on the part of an operator to the high-voltage area. Moreover, the device indicates, by means of the LED 4, the presence of said voltage.

If instead there is no voltage, the capacitive means 3 are not charged and therefore no control signal is sent to the electric lock, which in the absence of the control signal opens, since the contact 10 of the relay, if there is no voltage, returns to the normally-open position.

Likewise, the contact 12 of the relay reopens, since it does not have to send any voltage presence signal.

If a short-circuit occurs or LED control or adjustment part opens, this does not entail any interference in the operation of vehicle on which the device is installed, other than the indication ceasing to operate.

Substantially, the electric lock 11 is therefore actuated to close in the presence of high voltage and is instead actuated to open otherwise.

All this is done automatically, thus detecting the voltage that is present in a specific area.

In practice it has been found that the device according to the present invention fully achieves the intended aim and objects, since it allows to control automatically the electric lock, so as to prevent access to the high-voltage area if said voltage is actually present.

The device thus conceived is susceptible of numerous modifications and variations, all of which are within the scope of the appended claims; all the details may further be replaced with other technically equivalent elements.

What is claimed is:

1. A permission device for an electric safety lock, particularly for inhibiting access to high-voltage areas, comprising high-voltage resistive means, which receive in input the voltage of said area and are adapted to produce a voltage drop, capacitive means being connected in series to said resistive means and being adapted to be charged by said resistive means, at least one control diode of an optical fiber being arranged so as to receive the discharge of said capacitive means, oscillator means being adapted to drive at least one indicator LED, said optical fiber sending a signal giving or denying permission to release said lock.

2. The device according to claim 1, comprising a MOSFET transistor driven by said oscillator means, said MOSFET transistor allowing the discharge of said capacitive means.

3. The device according to claim 1, wherein said optical fiber is adapted to drive an additional MOS transistor, which is adapted to transduce an intermittent optical signal emitted by said optical fiber into a control for driving a coil of a relay.

4. The device according to claim 3, wherein said relay is provided with two normally-open contacts, a first contact being adapted to control a coil of an electric lock and a second contact being adapted to send a signal indicating the presence of voltage.

5. An electric lock, comprising a device according to claim 1.
